(19) United States
(12) Patent Application Publication
(10) Pub. No.: US 2021/0376411 A1
(43) Pub. Date: Dec. 2, 2021

(54) DIRECT TEMPERATURE REGULATION OF BATTERIES

(71) Applicant: GM GLOBAL TECHNOLOGY OPERATIONS LLC, Detroit, MI (US)

(72) Inventors: Chih-hung YEN, Bloomfield Hills, MI (US); David R. CLARK, Grosse Pointe Woods, MI (US); Matthew SWIFT, Detroit, MI (US); Taeyoung HAN, Bloomfield Hills, MI (US); Kuo-huey CHEN, Troy, MI (US); Bahram KHALIGHI, Birmingham, MI (US); Goro TAMAI, Bloomfield Hills, MI (US); Chih-cheng HSU, Bloomfield Township, MI (US)

(73) Assignee: GM GLOBAL TECHNOLOGY OPERATIONS LLC, Detroit, MI (US)

(21) Appl. No.: 16/888,304

(22) Filed: May 29, 2020

(51) Int. Cl. H01M 10/6568; H01M 10/613; H01M 10/625

(52) U.S. Cl. CPC H01M 10/6568; H01M 2220/20; H01M 10/625; H01M 10/613

(57) ABSTRACT

A temperature regulation system for a battery is provided. The temperature regulation system includes an electrochemical cell, which may be in the form of a battery. The electrochemical cell includes a housing having a first side surface that extends from a first end to a second end, and a first temperature control chamber containing a dielectric fluid. The first temperature control chamber is located along the first side surface of the housing or along at least one of the first end or the second end of the housing. The dielectric fluid is in direct contact with the housing at the first side surface or at the first end or the second end.

### INTRODUCTION

This section provides background information related to the present disclosure which is not necessarily prior art.

Electrochemical energy storage devices, such as lithium-ion batteries, can be used in a variety of products, including automotive products, such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes, a separator, and an electrolyte. One of the two electrodes serves as a positive electrode or cathode, and the other electrode serves as a negative electrode or anode. Lithium-ion batteries may also include various terminal and packaging materials. Conventional rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include a solid-state electrolyte disposed between solid-state electrodes, the solid-state electrolyte physically separates the electrodes so that a distinct separator is not required.

When operating at elevated temperatures, electrochemical cells, including batteries, can be subject to capacity loss, power fade, and in certain circumstances, thermal runaway. On the other hand, operating at temperatures that are too low may result in increased resistance, increased plating, and decreased capacity. Therefore, maintaining a desired operating temperature range maximizes the efficiency and lifespan of electrochemical cell. Accordingly, temperature regulation systems electrochemical cells are desirable.

### SUMMARY

This section provides a general summary of the disclosure, and is not a comprehensive disclosure of its full scope or all of its features.

The present disclosure relates to direct temperature regulation of batteries.

In various aspects, the current technology provides a temperature regulation system for an electrochemical cell, such as a battery. The temperature regulation system includes an electrochemical cell, the electrochemical cell including a housing having a first side surface that extends from a first end to a second end, and a first temperature control chamber containing a dielectric fluid disposed along at least one of: the first side surface of the housing, the first end of the housing, or the second end of the housing, wherein the dielectric fluid is in direct contact with the housing along at least one of: the first side surface of the housing, the first end of the housing, or the second end of the housing.

In one aspect, the temperature regulation system further includes a pump configured to pump the dielectric fluid into the first temperature control chamber through a temperature control chamber inlet port and out of the first temperature control chamber through a temperature control chamber outlet port.

In one aspect, temperature regulation system includes the first temperature control chamber located on a first end of the electrochemical cell and a second temperature control chamber located on the second end of the electrochemical cell, wherein the temperature regulation system further includes a conduit extending from the first temperature control chamber to the second temperature control chamber so that the first temperature control chamber and the second temperature control chamber are in fluid communication.

In one aspect, the at least one of the first end or the second end of the electrochemical cell includes a tab, and the dielectric fluid is in direct contact with the tab.

In one aspect, the electrochemical cell further includes a second side surface opposite to the first side surface and the temperature regulation system includes the first temperature control chamber located along the first side surface and a second temperature control chamber located along the second side surface, wherein the temperature regulation system further includes a conduit extending from the first temperature control chamber to the second temperature control chamber so that the first temperature control chamber and the second temperature control chamber are in fluid communication.

In one aspect, the temperature regulation system further includes a first spacer disposed along the first side surface within the first temperature control chamber, and a second spacer disposed along the second side surface within the second temperature control chamber, wherein the first and second spacers are porous and comprise a thermally conductive material.

In one aspect, the electrochemical cell includes a first plate extending outward form the first side edge and a second plate extending outward from the second side edge, the first and second plate including a thermally conductive metal, and the first temperature control chamber and the second temperature control chamber are positioned so that the dielectric fluid is in direct contact with the first and second plates.

In one aspect, the electrochemical cell further includes opposing third and fourth side surfaces orthogonal to the first and second side surfaces, and the electrochemical cell is positioned so that the first side surface and the first temperature control chamber are located above the second side surface and the second temperature control chamber, and the first temperature control chamber includes a plurality of apertures configured to allow the dielectric fluid to pour down along the third and fourth side surfaces by gravity, and the second temperature control chamber is configured to receive the dielectric fluid pouring down from the first temperature control chamber and to direct the dielectric fluid to a collector.

In one aspect, the electrochemical cell is a cylindrical cell.

In one aspect, the first temperature control chamber encapsulates the entire electrochemical cell and the dielectric fluid flows through the first temperature control chamber in a direction of from the first end to the second end of the electrochemical cell, and the first temperature control chamber includes active or passive agitators for disrupting the flow of the dielectric fluid.

In one aspect, the battery is a pouch battery or a prismatic battery.

In one aspect, the temperature regulation system further includes a heater for heating the dielectric fluid, wherein the heated dielectric fluid is configured to heat the electrochemical cell.

In various aspects, the current technology also provides a temperature regulation system for a battery pack, the temperature regulation system including a plurality of electrochemical cells aligned in a stack and defining the battery pack, the battery pack including a first side surface and an opposing second side surface, a first stack edge and an opposing stack edge, the first and second stack edges being orthogonal to the first and second side surfaces, and a first stack end and an opposing second stack end, the first and second side surfaces and the first and second stack edges extending from the first stack end to the second stack end, and first and second temperature control chambers disposed either on the first stack end and the second stack end, respectively, or on the first stack edge and the second stack edge, respectively, wherein the first and second temperature control chambers contain a dielectric fluid, the dielectric fluid being in direct contact with the battery pack.

In one aspect, the dielectric fluid has a dielectric strength greater than or equal to about 3 MV/m.

In one aspect, the first stack end includes a first plurality of tabs extending outward from the first stack end and the second tab end includes a second plurality of tabs extending outward from the second stack end, wherein the first and second temperature control chambers are disposed on the first stack end and the second stack end such that the dielectric fluid contacts the first and second pluralities of tabs.

In one aspect, temperature regulation system further includes a first conduit extending from a first outlet of the first temperature control chamber to a first inlet of the second temperature control chamber, a second conduit extending from a second outlet of the second temperature control chamber to a first inlet of the first temperature control chamber, and a pump associated with either the first conduit or the second conduit, wherein the pump provides directional flow of the dielectric fluid through the first and second temperature control chambers.

In one aspect, wherein at least one of the first conduit or the second conduit passes through an adjunct component that benefits form temperature regulation, such that the dielectric fluid regulates the temperature of the adjunct component.

In various aspects, the current technology yet further provides a method of regulating an operating temperature of an electrochemical cell, the method including directly contacting the electrochemical cell with a dielectric fluid.

In one aspect, the electrochemical cell includes a housing having a first side surface that extends from a first end to a second end, wherein the dielectric fluid flows through at least one temperature control chamber, the at least one temperature control chamber being disposed on the electrochemical cell along at least one of: the first side surface of the housing, the first end of the housing, or the second end of the housing.

In one aspect, the along at least one of: the first side surface of the housing, the first end of the housing, or the second end of the housing is a battery pack including a plurality of pouch cells, a prismatic cell, or a cylindrical cell.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a two-dimensional schematic illustration of an example of an electrochemical cell in the form of a battery.

FIG. 1B is a three-dimensional schematic illustration of the example of the electrochemical cell.

FIG. 2A is an illustration of a first example of a system for regulating the temperature of an electrochemical cell in the form of a battery in accordance with various aspects of the current technology.

FIG. 2B is an illustration of a second example of a system for regulating the temperature of an electrochemical cell in accordance with various aspects of the current technology.

FIG. 3A is an illustration of a pouch cell.

FIG. 3B is an illustration of a battery pack including a plurality of pouch cells.

FIG. 4A is a first view of another system for regulating the temperature of an electrochemical cell in the form of a battery in accordance with various aspects of the current technology.

FIG. 4B is a second view of the system shown in FIG. 4A.

FIG. 4C is a third view of the system shown in FIG. 4A.

FIG. 5A is a first view of another system for regulating the temperature of an electrochemical cell in the form of a battery in accordance with various aspects of the current technology.

FIG. 5B is a second view of the system shown in FIG. 5A.

FIG. 6A is a first view of another system for regulating the temperature of an electrochemical cell in the form of a battery in accordance with various aspects of the current technology.

FIG. 6B is a second view of the system shown in FIG. 6A.

FIG. 6C is a third view of the system shown in FIG. 6A.

FIG. 7A is a view of another system for regulating the temperature of an electrochemical cell in the form of a battery in accordance with various aspects of the current technology, wherein the system includes active agitators.

FIG. 7B is a view of another system for regulating the temperature of an electrochemical cell in the form of a battery in accordance with various aspects of the current technology, wherein the system includes passive agitators.

FIG. 7C shows illustrations of examples of passive agitators prepared in accordance with various aspects of the current technology.

FIG. 8A is a first view of another system for regulating the temperature of an electrochemical cell in accordance with various aspects of the current technology.

FIG. 8B is a second view of the system shown in FIG. 8A.

FIG. 8C is a third view of the system shown in FIG. 8A.

FIG. 9 shows a battery pack including spacers of a thermally-conductive material disposed between pouch cells in accordance with various aspects of the current technology.

FIG. 10 shows a pouch cell having thermally-conductive plates extending outwardly from edges of a pouch cell, wherein temperature regulation chambers are disposed on the thermally-conductive plates in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Electrochemical cells may be operated at temperatures of greater than or equal to about −20° C. to less than or equal to about 60° C. to promote extending efficiency and lifetime of the electrochemical cell. Accordingly, the current technology provides systems and methods for regulating the operating temperature of electrochemical cells. The system is employable, for example, in a vehicle. Non-limiting examples of vehicles that can benefit from the systems and methods include automobiles, motorcycles, boats, tractors, buses, mobile homes, campers, all-terrain vehicles, snowmobiles, airplanes, and tanks.

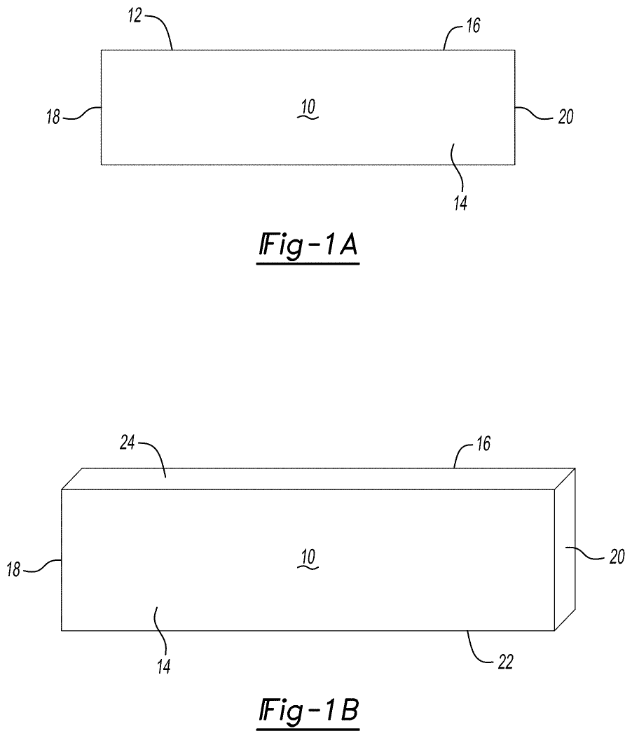

An exemplary electrochemical cell 10 is shown in FIGS. 1A and 1B. The electrochemical cell 10 may be a battery that is in the form of a pouch cell, a plurality of pouch cells defining a battery pack, a prismatic cell, a cylindrical cell. In certain aspects of the current technology, the electrochemical cell 10 is battery, rather than a fuel cell or other type of electrochemical device. The electrochemical cell 10 can cycle ions, such as lithium ions or sodium ions, and can have a liquid electrolyte or be a solid-state battery or an all-metal battery. The electrochemical cell 10 has a housing 12 comprising a first side surface 14 and optionally a second side surface 16 that extend form a first end 18 to an opposing second end 20. For example, when the electrochemical cell 10 is a cylindrical cell, it has only the first side surface 14, which is cylindrical. However, when the electrochemical cell 10 is a pouch cell or a prismatic cell, it has both the first side surface 14 and the second side surface 16. The housing encapsulates and protects electrochemical cell components, such as an anode, a cathode, at least one current collector, and a separator and/or an electrolyte, as non-limiting examples.

FIG. 1B is a three dimensional view of the electrochemical cell 10 when it includes the first and second side surfaces 14, 16. Here, the electrochemical cell 10 also comprises opposing first and second edges 22, 24 that extend from the first end 18 to the second end 20 of the housing 12 and that are orthogonal to the first and second side surfaces 14, 16.

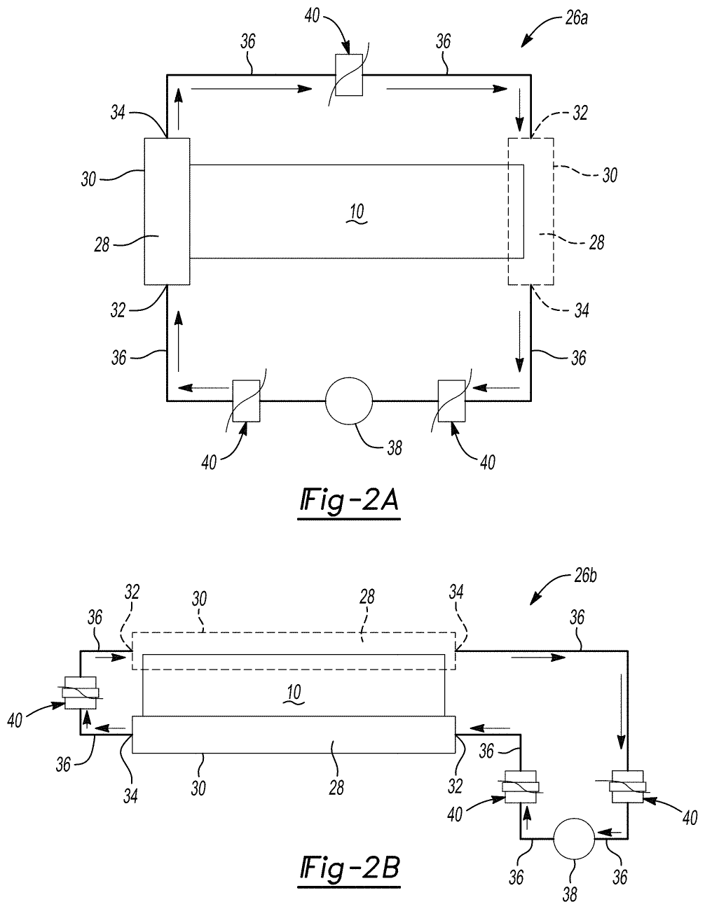

With reference to FIG. 2A, the current technology provides a system 26a for regulating the temperature of the electrochemical cell 10. The system comprises the electrochemical cell 10 and a temperature control chamber 28. The temperature control chamber 28 has a chamber housing 30, an inlet port 32, and an outlet port 34. The inlet and outlet ports 32, 34 are in fluid communication by way of an interior compartment defined by the housing or a flow channel. The temperature control chamber 28 contains or carries a dielectric fluid that is in direct contact with the electrochemical cell 10, such as with the electrochemical cell housing 12. The system 26a also comprises at least one conduit 36 and at least one pump 38. The conduit 36, as non-limiting examples, is a tube or hose. The pump 36 establishes and maintains directional flow of the dielectric fluid through the conduit 36, through the temperature control chamber 28, and back to the pump 36 as shown by arrows. With this configuration, flow of the dielectric fluid can be maintained continuously or discontinuously depending on a desired operation of the pump 38. In some aspects, the conduit 36 passes through or near additional units or components 40 that also require temperature regulation or that conditions the dielectric fluid, such as a heater, as described in more detail below.

As shown in FIG. 2A (with reference to FIGS. 1A and 1B), the temperature control chamber 28 is disposed on the first end 18 of the electrochemical cell 10. With this configuration, the dielectric fluid is in direct contact with the first end 18 of the electrochemical cell 10. However, it is understood that the system 26a can further comprise a second temperature control chamber 28 disposed on the second end 20 of the electrochemical cell 10. When the system 26a includes more than one temperature control chamber 28, they are in fluid communication with each other by way of the conduit 36. The pump 38 establishes directional flow of the dielectric fluid through the first and second temperature control chambers 28.

FIG. 2B shows another system 26b. The system 26b is similar to the system 26a of FIG. 2A. The difference here is that the temperature control chamber 28 is disposed on the first edge 22 of the electrochemical cell 10. With this configuration, the dielectric fluid is in direct contact with the first edge 22 of the electrochemical cell 10. However, it is understood that the system 26b can further comprise a second temperature control chamber 28 disposed on the second edge 24 of the electrochemical cell 10.

Although not shown, the temperature control chamber 28 can be disposed on at least one of the first side surface 14 or the second side surface 16 of the electrochemical cell 10 or in any combination of ends 18, 20, edges, 22, 24, or side surfaces 14, 16. Accordingly, the systems 26a, 26b comprise at least one temperature control chamber 28.

The dielectric fluid is in direct contact with the electrochemical cell 10 within the at least one temperature control chamber 28. Heat generated during operation of the electrochemical cell 10 is transferred to the dielectric fluid. As a result, the heated electrochemical cell 10 is cooled. In contrast, when the electrochemical cell is idle or operating under cold environmental conditions, the dielectric fluid is conditioned or heated by a heater, such as a positive temperature coefficient (PTC) heater, and heat exchange between the dielectric fluid and the electrochemical cell 10 can cause elevation of the electrochemical cell temperature, i.e., the electrochemical cell 10 is heated. Through the systems 26a, 26b, the operating temperature of the electrochemical cell 10 is cooled or heated as necessary in order to maintain temperature of greater than or equal to about −20° C. to less than or equal to about 60° C.

In certain aspects, the dielectric fluid may have a boiling point of greater than or equal to about −40° C. to less than or equal to about 200° C., greater than or equal to about 10° C. to less than or equal to about 180° C., or greater than or equal to about 60° C. to less than or equal to about 85° C., by way of example. The dielectric fluid may be configured to undergo phase change between a liquid state and a gas state and can be non-flammable. In certain aspects, the dielectric fluid comprises hydrocarbons, perfluorocarbons, or combinations thereof, by way of example. In certain other aspects, the dielectric fluid has a breakdown voltage or dielectric strength that is quantifiable by a critical voltage over a 0.1 inch gap between electrodes. The dielectric fluid can have a dielectric strength of greater than or equal to about 3 MV/m. Non-limiting examples of dielectric fluids include Novec™ 7500 dielectric fluid by 3M, MiVolt® DFK dielectric fluid by M&I Materials, Mobil EV Therm Elite™ 701 dielectric fluid by ExxonMobil, and combinations thereof.

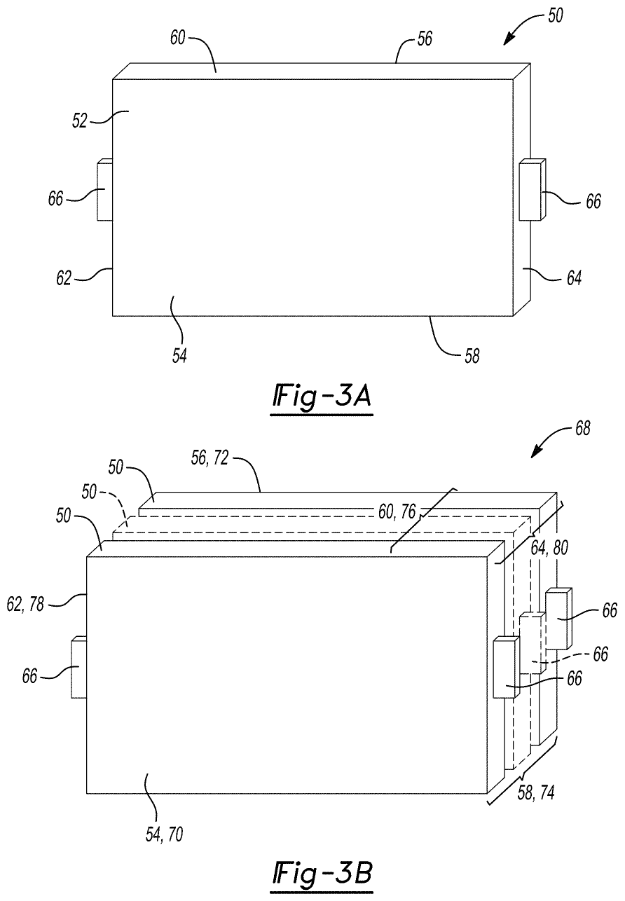

Additional aspects of the current technology are described with reference to FIGS. 3-10. These aspects are provided in view of a battery comprising a plurality of pouch cells that define a battery pack. However, it is understood that the systems and methods are applicable to pristine cells and cylindrical cells as well.

An exemplary pouch cell 50 is shown in FIG. 3A. The pouch cell 50 comprises a housing 52 having opposing first and second cell walls 54, 56 and opposing first and second cell edges 58, 60 orthogonal to the cell walls 54, 56. The first and second cell walls 54, 56 and first and second cell edges 58, 60 extend from a first cell end 62 to an opposing second cell end 64 of the housing 52. As shown in FIG. 3A, the pouch cell 50 may also include tabs 66 extending generally outwardly from at least one of the first or second ends 62, 64. The housing 52 at least partially encapsulates at least one electrochemical cell comprising at least one cathode and at least one anode separated by a separator, and an electrolyte, wherein the separator and the electrolyte can be a single component, such as in a solid state cell or an all metal cell. In certain aspects, the pouch cell 50 comprises two tabs 66, one tab 66 being associated with the at least one cathode and the other tab 66 being associated with the at least one anode. The two tabs 66 can be located on opposing cell ends 62, 64 as shown in FIG. 3A or they can both be located on a single end, the single end being either the first cell end 62 or the second cell end 64.

As shown in FIG. 3B, a plurality of the pouch cells 50 can be stacked to define a battery pack 68. The plurality of pouch cells 50 can be stacked as a “toast” cell stack or as a “pancake” cell stack, as non-limiting examples. The plurality of pouch cells 50 comprises at least 2 pouch cells 50. The central pouch cell 50 shown with dashed lines shows either that the central pouch cell 50 is optional or can be any number of pouch cells 50, such as greater than or equal to 1 to less than or equal to about 50 pouch cells 50.

The battery pack 68 comprises a first side surface 70 defined by a first cell wall 54 of a first pouch cell 50 of the plurality, an opposing second side surface 72 defined by a second cell wall 56 of a last pouch cell 50 of the plurality, and opposing first and second stack edges 74, 76 defined by the first and second cell edges 58, 60 of each pouch cell 50 of the plurality. The first and second stack edges 74, 76 are orthogonal to the first and second side surfaces 70, 72. The battery pack 68 also comprises opposing first and second stack ends 78, 80 defined by the first and second cell ends 62, 64 of each pouch cell 50 of the plurality. Although the tabs 66 of each pouch cell 50 are shown exposed in the figure, it is understood that they can be connected, such as with a bus bar as a non-limiting example.

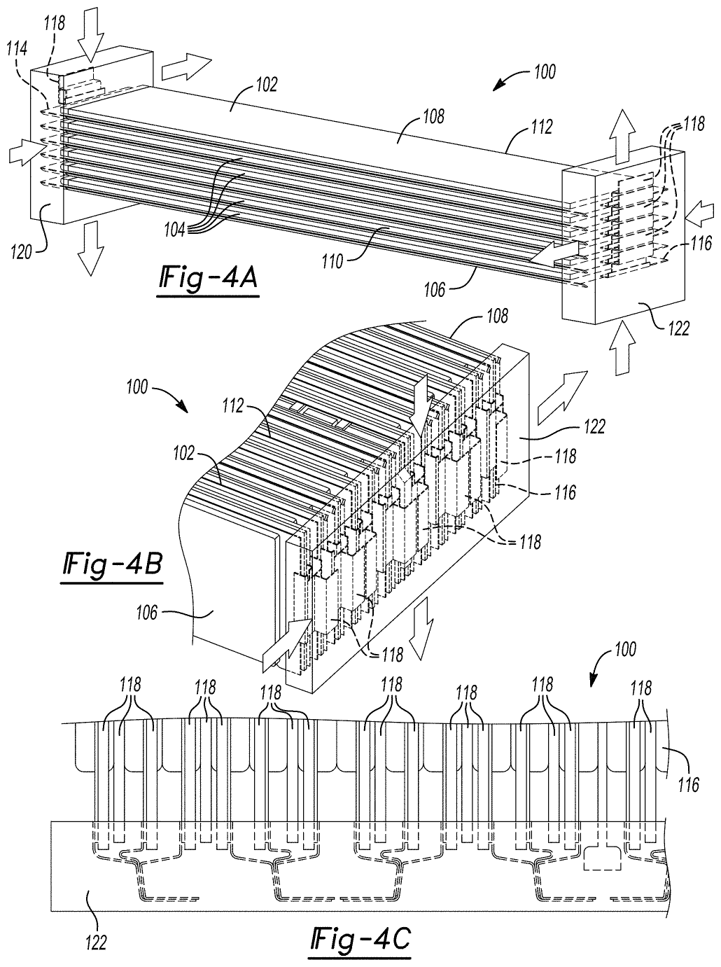

With reference to FIGS. 4A-4C, the current technology provides a temperature regulation system 100 for an electrochemical cell, where the electrochemical cell may be in the form of a battery that includes a plurality of battery cells that define a battery pack 102. The battery pack 102 has features that correspond to those described above with reference to FIGS. 3A-3B. In particular, the batty pack 102 comprises a plurality of electrochemical cells 104 aligned in a stack and defining the battery pack 102. The battery pack includes a first side surface 106 and an opposing second side surface 108, a first stack edge 110 and an opposing stack edge 112, the first and second stack edges 110, 112 being orthogonal to the first and second side surfaces 106, 108, and a first stack end 114 and an opposing second stack end 116, the first and second side surfaces 106, 108 and the first and second stack edges 110, 112 extending from the first stack end 114 to the second stack end 116. A plurality of tabs 118 extend generally outwardly from each electrochemical cell 104 of the plurality at the first and second stack ends 114, 116.

The system 100 further comprises a first temperature control chamber 120 disposed on or about the first stack end 114 and a second temperature control chamber 122 disposed on or about the second stack end 116. The first and second temperature control chambers 120, 122 contain a dielectric fluid that is in direct contact with the battery pack 102 at the first and second stack ends 114, 116. The dielectric fluid flows through the temperature control chambers 120, 122 in any direction, as shown by the block arrows. Although the arrows show two linear directions at each temperature control chamber 120, 122, the flow can be in any direction on opposite or adjacent ends of each temperature control chamber 120, 122. Although not shown in the figures, conduits carry the dielectric fluid into each temperature control chamber 120, 122 by way of an inlet port and out of each temperature control chamber 120, 122 by way of an outlet port. With flow of the dielectric fluid being established by a pump, the dielectric fluid circulates throughout the system 100.

As discussed above, the dielectric fluid contacts the battery pack 102 at the first and second stack ends 114, 116. More particularly, within each temperature control chamber 120, 122, the dielectric fluid contacts at least one of the stack ends, 114, 116, the tabs 118, or a bus bar connecting the tabs 118. Therefore, the dielectric fluid can contact any combination of the stack ends 114, 116, the tabs 118, and a bus bar, or only one of the stack ends 114, 116, the tabs 118, and a bus bar. For example, FIG. 4B shows exemplary flow paths of the dielectric fluid, which contact the stack end 116 and the tabs 118 and FIG. 4C shows exemplary flow paths of the dielectric fluid, which contact the tabs 118 only (along with connecting electronics).

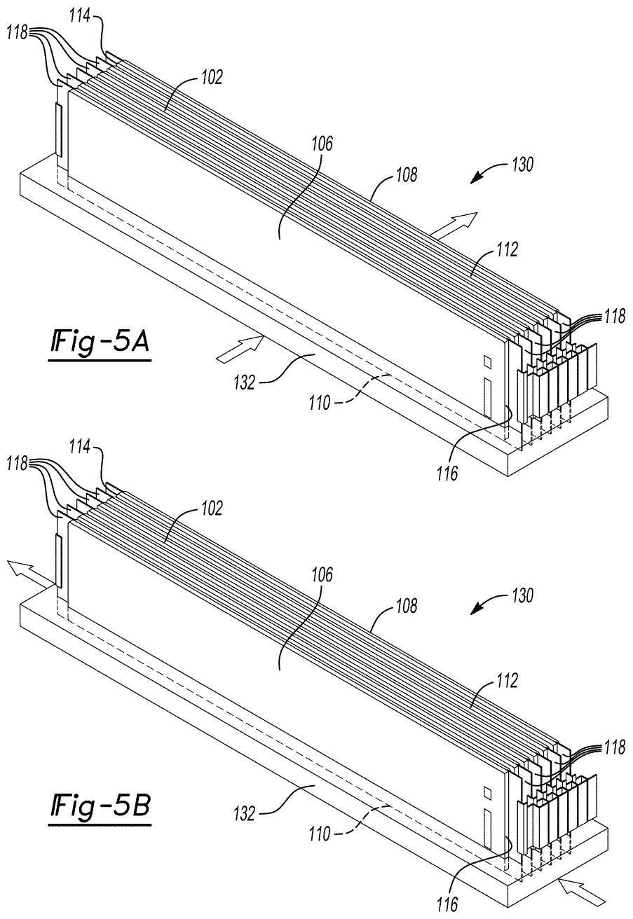

With reference to FIGS. 5A-5B, the current technology provides another temperature regulation system 130 for the battery pack 102. Here, a temperature control chamber 132 is disposed on or about the first stack edge 110 of the battery pack 102 so that the dielectric fluid is in direct contact with the first edge 110. In FIG. 5A, the dielectric fluid flows in a direction of from the first side wall 106 to the second side wall 108 and in FIG. 5B, the dielectric fluid flows in a direction of from the second stack end 116 to the first stack end 114. However, it is understood that the dielectric fluid can be carried to and from the temperature control chamber 132 by way of conduits coupled to the temperature control chamber 132 at an inlet port and an outlet port in any direction as long as system flow of the dielectric fluid is maintained. Also, although not shown in the figures, the system 130 can also comprises a second temperature control chamber disposed on the second stack edge 112 of the battery pack 102.

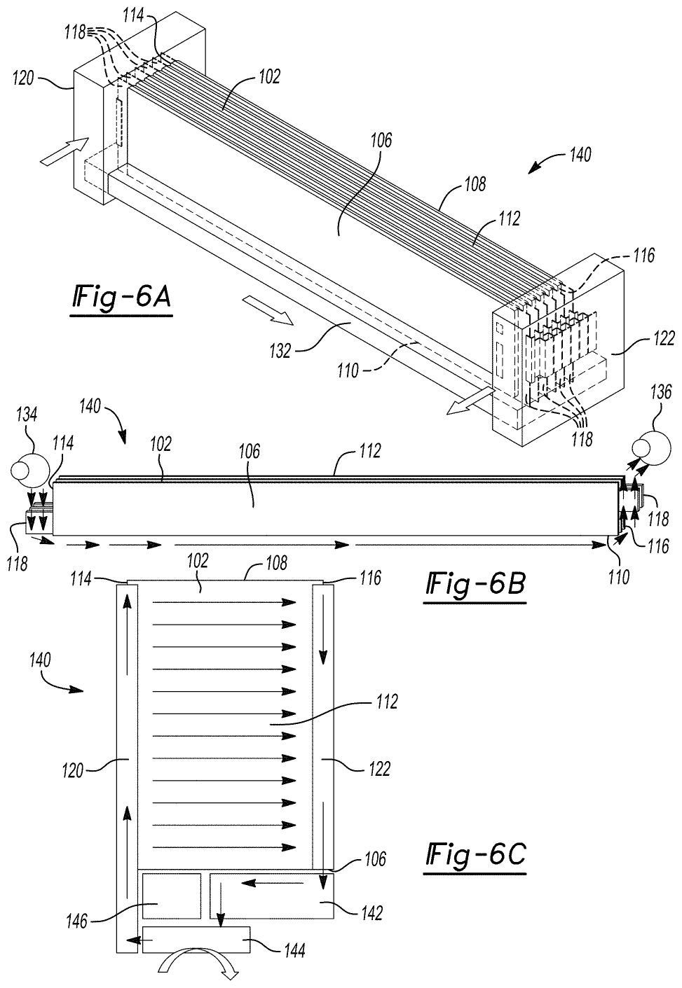

FIGS. 6A-6C show another exemplary system 140. Here, the temperature control chambers 120, 122 described with reference to FIGS. 4A-4C are disposed on or about the first and second stack ends 114, 116 of the battery pack 102, respectively. Additionally, the second temperature control chamber 132 described with reference to FIGS. 5A-5B is disposed on the first stack edge 110 of the battery pack 102. As shown by the arrows, the dielectric fluid flows in direct contact with the battery pack 102 from the temperature control chamber 120 at the first stack end 114, through the second temperature control chamber 132 at the first stack edge 110, and through the temperature control chamber 122 at the second stack end 116.

FIG. 6B shows the flow direction of the dielectric fluid in detail. It is shown here that the dielectric fluid enters the temperature control chamber 120 at the first stack end 114 by way of an inlet port 134. The temperature control chamber 120 at the first stack end 114 is in fluid communication with the second temperature control chamber 132 either directly or by way of a conduit. Similarly, the second temperature control chamber 132 is in fluid communication with the temperature control chamber 122 at the second stack end 116 either directly or by way of a conduit. As such, the dielectric fluid exits the temperature control chamber 122 at the second stack end 114 by way of an outlet port 136.

As shown in FIG. 6C, the system 140 can include regulating the temperature of additional components. Here, as the dielectric fluid leaves the outlet it is carried to, for example, power electronic (PE) bays 142, a heat exchanger 144, optionally associated with a chiller loop (represented by the arrow at 144), and other miscellaneous components 146. As such, the dielectric fluid regulates the temperature of the PE bays 142 and other miscellaneous components 146 before it returns the temperature control chamber 120 at the first stack end 114. Accordingly, at least one adjunct component requiring temperature regulation can be associated with any of the systems described herein.

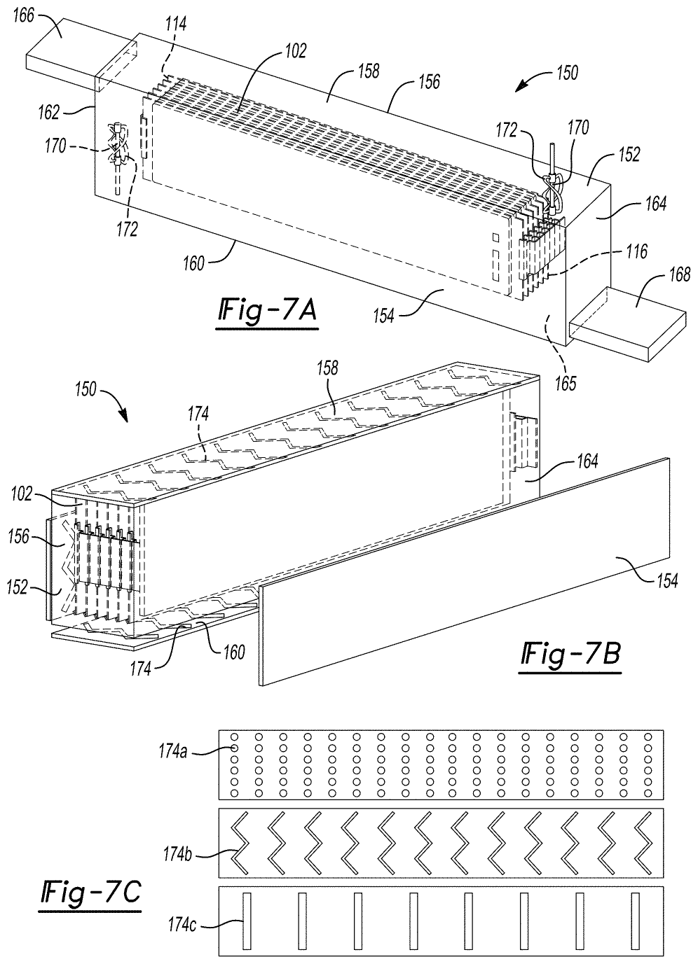

FIGS. 7A-7B show a system 150 comprising a temperature control chamber 152 that encapsulates the entire batter pack 102. The temperature control chamber 152 comprises opposing first and second side walls 154, 156, opposing upper and lower walls 158, 160 orthogonal to the first and second side walls 154, 156, and a first end wall 162 and an opposing second end wall 164. The side walls 154, 156 and upper and lower walls 158, 160 extend from the first end wall 162 to the second end wall 164 to define an interior compartment 165 that contains the battery pack 102 and the dielectric fluid. Here, the dielectric fluid enters the temperature control chamber 152 at an inlet 166 upstream of the first stack end 114 and exits the temperature control chamber 152 at an outlet 168 downstream of the second stack end 116. The dielectric fluid is in direct contact with the battery pack 102 as it flows through the temperature control chamber 152.

In order to increase heat transfer between the dielectric fluid and the battery pack 102, active or passive agitators can be included within the temperature control chamber 152. Thus, the active or passive agitators make the flow of the dielectric fluid less laminar and more turbulent.

As an example, in FIG. 7A the temperature control chamber 152 includes at least one active stirrer 170 as the active agitator. The at least one active stirrer 170 comprises a stirring component 172, such as a paddle, fin, or disrupter, that spins under either electrical power or non-electric power generated by the flow of the dielectric fluid. The at least one stirrer 170 is located anywhere within the temperature control chamber 152. In the figure, first and second stirrers 170 are shown near the first stack end 114 and near the second stack end 116, respectively. The active stirrers 170 make the flow of the dielectric fluid less laminar and more turbulent as it flows through the temperature control chamber 152.

As another example, in FIG. 7B at least one inner surface of the first side wall 154, the second side wall 156, the upper wall 158 and the lower wall 160 comprise a passive agitator 174. In the figure, the first side wall 154 is moved away from the temperature control chamber 152 to expose its interior for purposes of visualization. The passive agitator can have any geometrical shape, but can be seen in FIG. 7C as a plurality of dimples 174a, a plurality of W-shaped or zig-zag-shaped disruptors 174b, or a plurality of substantially straight rib turbulators 174c. Moreover, an individual inner surface can include any combination of passive agitators 174a, 174b, 174c. The passive agitator 174a, 1784b, 174c can protrude or extend into the interior compartment 165 or they can be etched into at least one inner surfaces of the first side wall 154, the second side wall 156, the upper wall 158 and the lower wall 160. The passive agitators 174 make the flow of the dielectric fluid less laminar and more turbulent as it flows through the temperature control chamber 152.

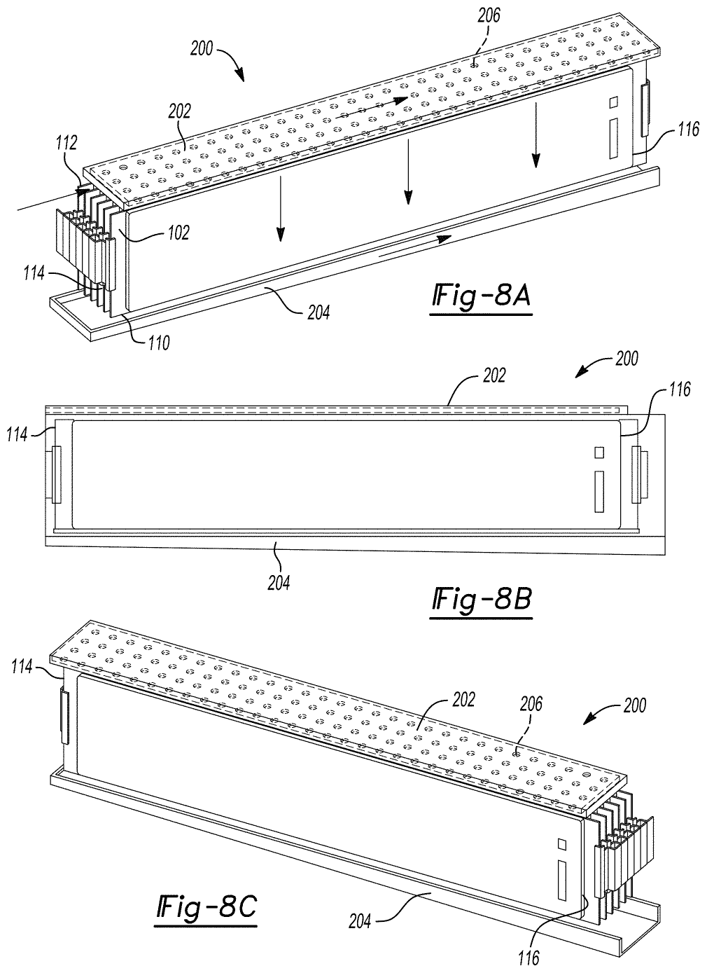

FIGS. 8A-8C show view of another system 200 for cooling the battery pack 102. The system 200 comprises a temperature control plate 202 as a temperature control chamber disposed on the second stack edge 112 and a fluid capture plate 204 disposed on the first stack edge 110. In the system 200, the battery pack 102 is positioned so that the second stack edge 112 defines a top surface and the first stack edge 110 defines a bottom surface. The temperature control plate 202 comprises a plurality of apertures 206 configured to spray dielectric fluid downward, such as like a showerhead or nozzles. Therefore, as the dielectric flows through the temperature control plate 202, it falls through the apertures 206 by way of gravity and falls into the fluid capture plate 206. As the dielectric fluid falls from the temperature control plate 202 to the fluid capture plate 206, it is in direct contact with the battery pack 102. The fluid capture plate 206 comprises a floor that declines in an upstream to downstream direction of the flow of the dielectric fluid. As shown in FIGS. 5A-5C, the floor declines form the first stack edge 114 toward the second stack edge 116. Although not shown, the system 200 can be encapsulated by a housing so that fluid is retained within the system. Also not shown, the system 200 can include a collection plate for collecting the dielectric fluid form the fluid capture plate and from where the dielectric fluid is circulated throughout the system 200 by way of conduits.

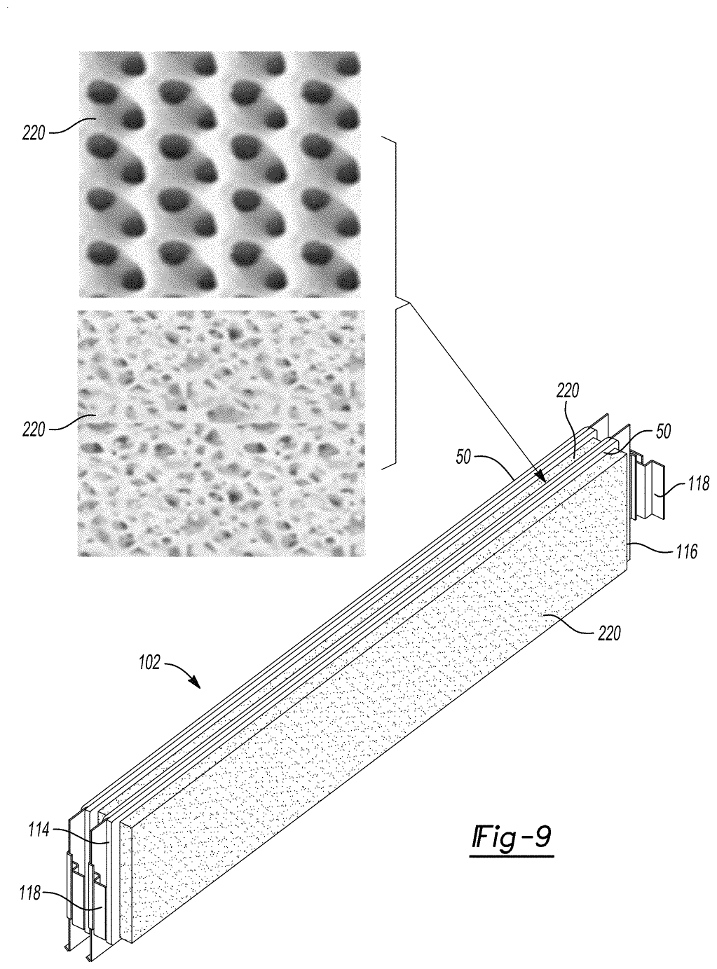

FIG. 9 shows an aspect of the current technology that can be applied to any of the systems described herein. Here a fluid transfer material 220 (or spacer) is disposed on outside edges of first and last pouch cells 50 and/or between pouch cells 50. However, the fluid transfer material 220 can be disposed on any surface of the battery pack 102 and/or between individual pouch cells 50. The fluid transfer material is porous, having a porosity of greater than or equal to about 10% to less than or equal to about 95% or greater than or equal to about 20% to less than or equal to about 90%, where “porosity” is a fraction of the total volume of pores over the total volume of the fluid transfer material 220. The fluid transfer material 220 is also thermally conductive and is configured to transfer the dielectric fluid to the battery pack 102 and to transmit heat away from the battery pack 102 to circulating dielectric fluid. The fluid transfer material 220 is also deformable and capable of contracting and expanding as the pouch cells 50 contract and expand during their operation. The fluid transfer material 220 comprises a thermally-conductive resin, such as a polycarbonate, a non-limiting example of which is TPN1125 polycarbonate resin by Mitsubishi.

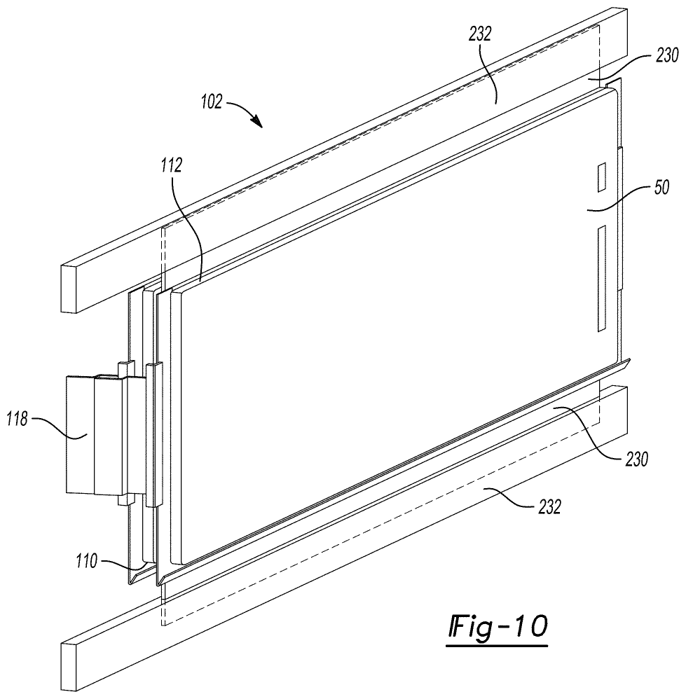

FIG. 10 shows another aspect of the current technology that can be applied to any of the systems described herein. Here, the battery pack 102 comprises at least one of a first thermally-conductive sheet or plate 230 extending generally outward form the first stack edge 110 or a second thermally-conductive sheet or plate 230 extending generally outward from the second stack edge 112. At least one temperature regulation chamber 232 is disposed on at least one of the thermally-conductive sheets or plates 230. Dielectric fluid within the at least one temperature regulation chamber 232 is in direct contact only with the at least one thermally-conductive sheet or plate 230. Here, heat is transferred to the dielectric fluid by way of the at least one thermally-conductive sheet or plate 230. As non-limiting examples, the at least one thermally-conductive sheet or plate 230 comprises graphene or graphite.

The current technology also provides a method of regulating an operating temperature of a electrochemical cell. The method includes employing any of the systems described herein. Accordingly, the method comprises directly contacting the electrochemical cell with a dielectric fluid as discussed herein. In certain aspects, the electrochemical cell comprises a housing having a first side surface that extends from a first end to a second end and the dielectric fluid flows through at least one temperature control chamber, the at least one temperature control chamber being disposed on the electrochemical cell at either the first side surface or one of the first end or the second end. In other aspects, the electrochemical cell is a battery pack comprising a plurality of pouch cells, a prismatic cell, or a cylindrical cell.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A temperature regulation system for an electrochemical cell comprising:
the electrochemical cell comprising a housing having a first side surface that extends from a first end to a second end; and
a first temperature control chamber that is disposed along at least one of: the first side surface of the housing, the first end of the housing, or the second end of the housing and contains a dielectric fluid, wherein the dielectric fluid is in direct contact with the housing along at least one of: the first side surface of the housing, the first end of the housing, or the second end of the housing.

2. The temperature regulation system according to claim 1, further comprising:
a pump configured to pump the dielectric fluid into the first temperature control chamber through a temperature control chamber inlet port and out of the first temperature control chamber through a temperature control chamber outlet port.

3. The temperature regulation system according to claim 1, comprising the first temperature control chamber located on a first end of the electrochemical cell and a second temperature control chamber located on the second end of the electrochemical cell, wherein the temperature regulation system further comprises a conduit extending from the first temperature control chamber to the second temperature control chamber so that the first temperature control chamber and the second temperature control chamber are in fluid communication.

4. The temperature regulation system according to claim 3, wherein the at least one of the first end or the second end of the electrochemical cell comprises a tab, and the dielectric fluid is in direct contact with the tab.

5. The temperature regulation system according to claim 1, wherein the electrochemical cell further comprises a second side surface opposite to the first side surface and the temperature regulation system comprises the first temperature control chamber located along the first side surface and a second temperature control chamber located along the second side surface,
wherein the temperature regulation system further comprises a conduit extending from the first temperature control chamber to the second temperature control chamber so that the first temperature control chamber and the second temperature control chamber are in fluid communication.

6. The temperature regulation system according to claim 5, further comprising a first spacer disposed along the first side surface within the first temperature control chamber, and a second spacer disposed along the second side surface within the second temperature control chamber, wherein the first and second spacers are porous and comprise a thermally conductive material.

7. The temperature regulation system according to claim 5, wherein the electrochemical cell comprises a first plate extending outward from a first side edge and a second plate extending outward from a second side edge, the first and second plate comprising a thermally conductive metal, and
wherein the first temperature control chamber and the second temperature control chamber are positioned so that the dielectric fluid is in direct contact with the first and second plates.

8. The temperature regulation system according to claim 5, wherein the electrochemical cell further comprises opposing third and fourth side surfaces orthogonal to the first and second side surfaces, and the electrochemical cell is positioned so that the first side surface and the first temperature control chamber are located above the second side surface and the second temperature control chamber, and:
the first temperature control chamber comprises a plurality of apertures configured to allow the dielectric fluid to pour down along the third and fourth side surfaces by gravity, and
the second temperature control chamber is configured to receive the dielectric fluid pouring down from the first temperature control chamber and to direct the dielectric fluid to a collector.

9. The temperature regulation system according to claim 1, wherein the electrochemical cell is a cylindrical cell.

10. The temperature regulation system according to claim 1, wherein the first temperature control chamber encapsulates the entire electrochemical cell and the dielectric fluid flows through the first temperature control chamber in a direction of from the first end to the second end of the electrochemical cell, and
wherein the first temperature control chamber comprises active or passive agitators for disrupting the flow of the dielectric fluid.

11. The temperature regulation system according to claim 1, wherein the electrochemical cell is a pouch cell or a prismatic cell.

12. The temperature regulation system according to claim 1, further comprising a heater for heating the dielectric fluid, wherein the heated dielectric fluid is configured to heat the electrochemical cell.

13. A temperature regulation system for a battery pack, the temperature regulation system comprising:
a plurality of electrochemical cells arranged in a stack and defining the battery pack, the battery pack comprising a first side surface and an opposing second side surface, a first stack edge and an opposing second stack edge, the first and second stack edges being orthogonal to the first and second side surfaces, and a first stack end and an opposing second stack end, the first and second side surfaces and the first and second stack edges extending from the first stack end to the second stack end; and
first and second temperature control chambers disposed either on the first stack end and the second stack end, respectively, or on the first stack edge and the second stack edge, respectively, wherein the first and second temperature control chambers each contain a dielectric fluid, the dielectric fluid being in direct contact with the battery pack.

14. The temperature regulation system according to claim 13, wherein the dielectric fluid has a dielectric strength greater than or equal to about 3 MV/m.

15. The temperature regulation system according to claim 13, wherein the first stack end comprises a first plurality of tabs extending outward from the first stack end, and the second stack end comprises a second plurality of tabs extending outward from the second stack end, and wherein the first and second temperature control chambers are disposed on the first stack end and the second stack end such that the dielectric fluid contacts the first and second pluralities of tabs.

16. The temperature regulation system according to claim 13, further comprising:
a first conduit extending from a first outlet of the first temperature control chamber to a first inlet of the second temperature control chamber;
a second conduit extending from a second outlet of the second temperature control chamber to a first inlet of the first temperature control chamber; and
a pump associated with either the first conduit or the second conduit,
wherein the pump provides directional flow of the dielectric fluid through the first and second temperature control chambers.

17. The temperature regulation system according to claim 16, wherein at least one of the first conduit or the second conduit passes through an adjunct component that benefits form temperature regulation, such that the dielectric fluid regulates the temperature of the adjunct component.

18. A method of regulating an operating temperature of an electrochemical cell, the method comprising:
directly contacting the electrochemical cell with a dielectric fluid.

19. The method according to claim 18, wherein the electrochemical cell comprises a housing having a first side surface that extends from a first end to a second end, and
wherein the dielectric fluid flows through at least one temperature control chamber, the at least one temperature control chamber being disposed on the electrochemical cell along at least one of: the first side surface of the housing, the first end of the housing, or the second end of the housing.

20. The method according to claim 18, wherein the electrochemical cell is a battery pack comprising a plurality of pouch cells, a prismatic cell, or a cylindrical cell.
